(19) United States
(12) Patent Application Publication
(10) Pub. No.: US 2024/0388117 A1
(43) Pub. Date: Nov. 21, 2024

(54) Battery Charge Controller

(71) Applicant: Lenovo (Singapore) Pte. Ltd., Singapore (SG)

(72) Inventors: Bouziane Yebka, Morrisville, NC (US); Tin-Lup Wong, Morrisville, NC (US); Philip J. Jakes, Morrisville, NC (US)

(21) Appl. No.: 18/197,466

(22) Filed: May 15, 2023

(51) Int. Cl. H02J 7/00; H01M 10/44

(52) U.S. Cl. CPC H02J 7/007194; H01M 10/443; H02J 7/0048

(57) ABSTRACT

A method can include charging a lithium-based battery at a first base charging rate associated with a first base period of time; responsive to a temperature of the lithium-based battery not exceeding a first temperature threshold, charging the lithium-based battery at a first elevated charging rate associated with a first elevated period of time to generate heat within the lithium-based battery; and responsive to the temperature of the lithium-based battery exceeding the first temperature threshold due in part to the generated heat, charging the lithium-based battery at a second base charging rate associated with a second base period of time.

### TECHNICAL FIELD

Subject matter disclosed herein generally relates to rechargeable batteries.

### BACKGROUND

Electrochemical cells include, for example, lithium-based cells. Such cells may be characterized, for example, as to specific energy (e.g., Wh/kg or MJ/kg), energy density (Wh/I or MJ/I), specific power (W/kg), etc. Various technologies and techniques described herein pertain to electrochemical cells, for example, including lithium-based cells.

### SUMMARY

A method can include charging a lithium-based battery at a first base charging rate associated with a first base period of time; responsive to a temperature of the lithium-based battery not exceeding a first temperature threshold, charging the lithium-based battery at a first elevated charging rate associated with a first elevated period of time to generate heat within the lithium-based battery; and responsive to the temperature of the lithium-based battery exceeding the first temperature threshold due in part to the generated heat, charging the lithium-based battery at a second base charging rate associated with a second base period of time. Various other apparatuses, systems, methods, etc., are also disclosed.

### BRIEF DESCRIPTION OF THE DRAWINGS

Features and advantages of the described implementations can be more readily understood by reference to the following description taken in conjunction with examples of the accompanying drawings.

FIG. 1 is a diagram of an example of a battery;

FIG. 2 is a diagram of an example of a lithium-ion cell;

FIG. 3 is a diagram of an example of a lithium-ion cell where an anode electrode includes graphite;

FIG. 4 is a diagram of examples of processes;

FIG. 5 is a diagram of an example of a control scheme;

FIG. 6 is a diagram of an example of a control scheme;

FIG. 7 is a diagram of an example of a control scheme;

FIG. 8 is a diagram of an example of a plot;

FIG. 9 is a diagram of examples of plots;

FIG. 10 is a diagram of an example of a plot;

FIG. 11 is a diagram of examples of plots;

FIG. 12 is a diagram of an example of a plot;

FIG. 13 is a diagram of an example of a plot;

FIG. 14 is a diagram of an example of a device;

FIG. 15 is a diagram of an example of a method;

FIG. 16 is a diagram of an example of a method and an example of a system;

FIG. 17 is a diagram of examples of devices; and

FIG. 18 is a diagram of an example of a system.

### DETAILED DESCRIPTION

The following description includes the best mode presently contemplated

for practicing the described implementations. This description is not to be taken in a limiting sense, but rather is made merely for the purpose of describing general principles of various implementations. The scope of invention should be ascertained with reference to issued claims.

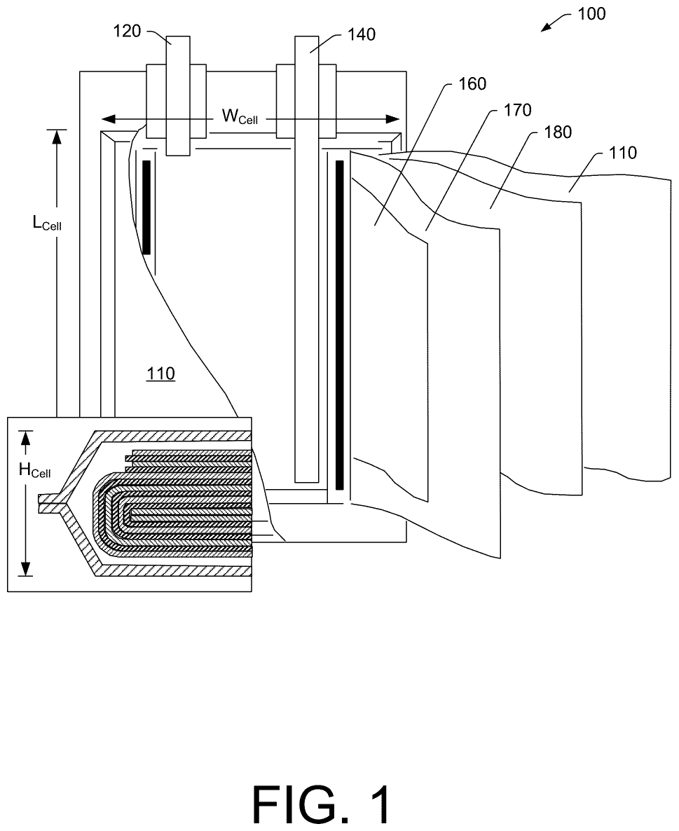

FIG. 1 shows an approximate cut-away view of an example of a battery

100 that includes a casing 110 and a positive tab 120 and a negative tab 140, for example, to operatively couple the battery 100 to circuitry. The casing 110 may include a cell region defined by a cell length (L_{Cell}), a cell width (W_{Cell}) and a cell height (H_{Cell}). As an example, the cell region may include one or more electrochemical cells. As an example, an electrochemical cell may be formed in part by a cathode 160, a separator 170 and an anode 180. Such components may be “folded”, for example, to form a stack (e.g., “jelly roll”) that may be housed in the cell region of the casing 110. As shown in the example of FIG. 1, in an approximate cross-sectional view, the height (H_{Cell}) of the cell region of the casing 110 may be defined in part by thicknesses of the cathode 160, the separator 170 and the anode 180 as well as, for example, by stacking of such components (e.g., winding in a roll or other configuration). As an example, a cathode formed of electrode material, an anode formed of electrode material and a separator formed of separator material along with collector materials may be layered and stacked, for example, by folding in a zigzag orientation, folding in a clockwise roll orientation, folding in a counterclockwise roll orientation, etc.

As an example, a region of a battery with one or more cells may include Lcell and Wcell dimensions (e.g., rectangular dimensions), for example, with a Lcell/Wcell ratio in a range of about 1 to about 5. As an example, consider a cell (or cells) with dimensions of about 120 mm (L_{Cell}) by about 100 mm (W_{Cell}) where, in combination with a height (H_{Cell}), a volume (Vol_{Cell}) may be calculated.

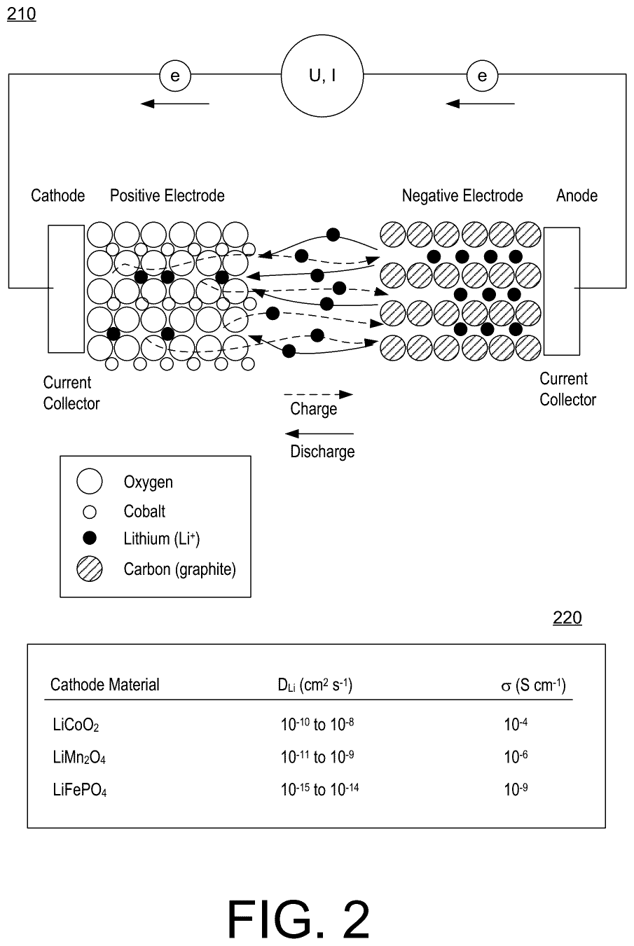

FIG. 2 shows a diagram of an example of a battery 210 and a table 220 that includes some examples of parameters for cathode materials (e.g., cathode electrode materials). In the example of FIG. 2, the battery 210 includes a cathode, an anode, a cathode current collector, an anode current collector, a positive electrode that includes oxygen and cobalt and a negative electrode that includes carbon (e.g., graphite, etc.). During charging, lithium ions (Li⁺) can pass from the positive electrode to the negative electrode and, during discharging, lithium ions (Li⁺) can pass from the negative electrode to the positive electrode. The table 220 shows some values for diffusion coefficients of lithium ions in various types of cathode materials that can function as positive electrodes (e.g., positive electrode materials or cathode materials) as well as some values for electrical conductivity of those various types of cathode materials.

In FIG. 2, the diffusion coefficient values are given in units of cm²s⁻¹ while the electrical conductivity values are given in units of Scm⁻¹. Diffusion may be described, for example, using one or more of Fick's laws. As to Fick's second law, it can be utilized to predict how diffusion can cause concentration to change with respect to time. In one dimension, consider the following partial differential equation:

$$\frac{\partial φ}{\partial t} = D \frac{{\partial }^{2} φ}{\partial {x}^{2}}$$

where φ is the concentration in dimensions of amount of substance per unit volume, which is dependent on time, where x is a position (e.g., length) and where D is the diffusion coefficient in units of length squared with respect to time (in two or more dimensions, the Laplacian may be utilized, as appropriate to generalize the second derivative).

According to Fick's second law, concentration and diffusion coefficient can impact diffusion where, for a given concentration, a smaller diffusion coefficient means a lesser change in concentration with respect to time. As can be seen in the table 220 of FIG. 2, the diffusion coefficients tend to be low and characteristic of solid materials (e.g., chemicals diffusing into or out of a solid matrix). For comparison, consider a volatile chemical diffusing in air where a diffusion coefficient may be of the order of about 0.1 cm²s⁻¹. Diffusion can play a role in behavior of a lithium-ion battery, for example, discharging rate (e.g., diffusion of lithium ions into a cathode material) can depend on the chemical and/or physical structure of the cathode material of the lithium-ion battery.

Diffusion can depend on temperature. For example, a diffusion coefficient for lithium ions can increase with temperature where, for example, at 50 degrees C., diffusion coefficient can be greater than that at 25 degrees C. Further, a diffusion coefficient for lithium ions at a relatively low temperature (e.g., 0 degrees C.) tends to be less than that at 25 degrees C.

During operation, heat can be generated responsive to current. Current transfer inside a lithium-ion battery (LIB) is driven by the potential gradient. In an article by Li et al., Three-Dimensional Thermal Modeling of Internal Shorting Process in a 20Ah Lithium-Ion Polymer Battery, February 2020, Energies 13 (4):1013, which is incorporated by reference herein, modeling results indicate for a particular LIB that current flow comes from a tab, goes into the whole cell, and goes back to a tab under normal discharging condition. Such current flow patterns can be utilized to model and characterize heat generation, dissipation and temperatures in LIBs. The article by Li et al., demonstrates that, under an internal shorting situation, current concentrates towards an internal short where, as the shorting resistance can be small, a large current can go through the internal short in an internal shorting process where the large current can then cause a sudden generation of heat, which may result in a detrimental thermal runaway. Thermal diffusion can be a factor in LIB operation as an inability to dissipate generated heat may lead to unstable operation (e.g., undesirable reactions), thermal stresses, etc.

As explained, a LIB can depend on diffusion of lithium ions where such diffusion can depend on temperature. And, temperature may be uneven within a LIB due to one or more factors, which can include current related factors, environmental factors, casing factors, etc. A LIB may benefit from a distribution of materials that can account for various factors such that, for example, spatial patterns of current, temperature and diffusion reduce risk of one or more performance issues (e.g., thermal hotspots, thermal runaway, thermal stresses, etc.) and/or improve performance.

Lithium-based cells (e.g., lithium-based batteries) can include lithium in one or more forms. Some types of lithium-based cells can be referred to as lithium-ion cells while other types can be referred to as lithium metal cells. As to the latter, consider, as an example, a rechargeable lithium metal battery that includes metallic lithium as a negative electrode (e.g., anode). In such an approach, the high specific capacity of lithium metal (3,860 mAhg⁻¹), very low redox potential (−3.040 V versus standard hydrogen electrode) and low density (0.59 gcm⁻³) make it a suitable anode material for high energy density battery technologies. Rechargeable lithium metal batteries can have a long run time due to the high charge density of lithium. Some rechargeable lithium metal batteries employ a liquid electrolyte and some employ a solid-state electrolyte.

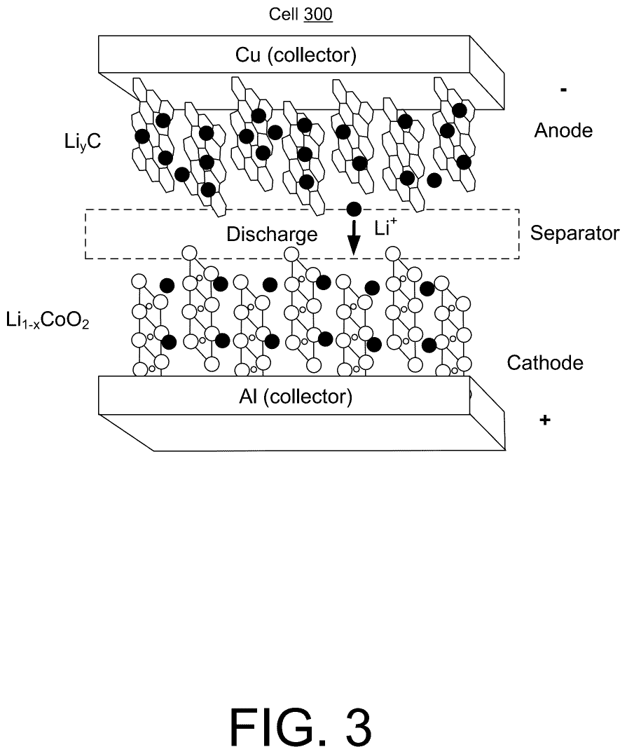

FIG. 3 shows an example of a cell 300, which may be utilized alone or to form a stack of cells. As shown, the cell 300 includes an anode collector material that includes, for example, copper; an anode electrode material that includes lithium and carbon (e.g., LiyC); a separator material configured for passage of lithium ions (e.g., in electrolyte); a cathode electrode material that includes lithium and metal oxide (e.g., Li₁₋ₓCoO₂); and a cathode collector material that includes, for example, aluminum. While carbon, cobalt, copper and aluminum are mentioned, other materials may be employed to form a lithium-ion cell.

As to the terms “anode” and “cathode”, these may be defined based on discharge, for example, where lithium ions migrate in a direction shown in FIG. 3 from a carbon-based matrix towards a metal oxide-based matrix. In other words, when a lithium-ion based cell is discharging, a positively charged lithium ion may be extracted from anode electrode material (e.g., a graphite lattice) and inserted into cathode electrode material (e.g., into a lithium containing compound); whereas, when such a cell is charging, the reverse process may occur (see, e.g., FIG. 2).

As an example, positive electrode material (e.g., cathode electrode material) may include LiCoO₂, LiMn₂O₄ or other compound (see, e.g., the table 220 of FIG. 2). As an example, separator material may include a conducting polymer electrolyte (e.g. polyethyleneoxide (PEO), etc.). For example, a separator material may include polymer that provides for conduction of lithium ions (e.g., a lithium-ion conductive polymer material). As an example, negative electrode material (e.g., anode electrode material) may include ionizable lithium metal, a carbon-lithium intercalation compound, etc.

As an example, a lithium-ion battery may include one or more cells where each cell includes an anode, a cathode and electrolyte, which may be a polymeric material or provided in a polymeric matrix. As an example, a cell may include an anode electrode material that includes carbon, a cathode electrode material that includes a metal oxide, and a separator material that includes polymer.

As an example, active electrode particles may be used for a cathode to form cathode electrode material. For example, consider particles that include one or more of lithium cobalt oxide (LiCoO₂) (LCO), lithium nickel oxide (LiNiO₂), lithium manganese oxide (LiMn₂O₄), and lithium iron phosphate (LiFePO₄).

As an example, positive active electrode particles may include lithium and metal oxide, for example, represented by LiₓM1_{y}M²_{1-y}O₂ where 0.4≤x≤1; 0.3≤y≤1; M¹ is at least one selected from the group consisting of Ni and Mn; and M² is at least one selected from the group consisting of Co, Al, and Fe. As an example, positive active electrode particles may include lithium and metal oxide, for example, be represented by one of the following: LiNiₓCo_{y}Al_{z}O₂, where 0.7≤x≤1; 0≤y≤0.3; 0≤z≤ 0.03; and 0.9≤x+y+z≤1.1; LiNiₓCo_{y}Mn_{z}O₂ (NMC), where 0.3≤x≤0.6; 0≤y≤0.4; 0.3≤z≤0.6; and 0.9≤x+y+z≤ 1.1; LiₓMn_{z}O₂, where 0.4≤x≤0.6; and 0.9≤z≤1; or LiFeₓCo_{y}Mn_{z}O₂, where 0.3≤x≤0.6; 0.1≤y≤0.4; 0.3≤z≤0.6; and 0.9≤x+y+z≤1.1. As an example, lithium iron phosphate (LiFePO₄) (LFP) may be utilized as an electrode material.

As an example, active electrode particles may be used for an anode to form anode electrode material. For example, consider particles that include one or more of carbon lithium and lithium titanate. As to lithium titanate, consider, for example: Li₂TiO₃; Li₄TiO₁₂; Li₄Ti₅O₁₂.

As an example, a cell may include electrolyte in a polymeric matrix. For example, consider an electrolyte that includes Li(ClO₄)₂ in polycarbonate/tetrahydrofuran (PC/THF) (e.g., about 0.4 M) or other polymeric matrix.

As an example, a cell can include a polymer composite material such as polyethylene oxide (PEO), polyacrylonitrile, etc. that includes lithium salt. Such a cell or cells may be referred to as a lithium-ion battery or a lithium-ion polymer battery or a lithium-polymer battery (e.g., “LiPo battery” or “LiPo cell”). LiPo cells are sometimes referred to as laminate cells, which may be configured very thin or quite large depending on their intended use. One or more LiPo cells may be encased in a flexible aluminum foil laminate pouch (e.g., with a thickness of the order of about 0.1 mm; see, e.g., the casing 110 of the battery 100 of FIG. 1). LiPo cells may include a stacked construction formed by stacking materials that include electrode and electrolyte materials in a flat sandwich (e.g., defined by length, width and height dimensions). Stacked layers may be packed in a package (see, e.g., the casing 110 of FIG. 1) in a flat, rolled or other configuration. LiPo cell capacities may include capacities in a range, for example of about 50 mA·hrs (e.g., for a small cell such as for a BLUETOOTH headset) to about 10 A·hrs or more for an electric vehicle (e.g., electric or hybrid).

As explained, in a lithium-ion cell, lithium ions can move from a negative electrode (e.g., anode) to a positive electrode (e.g., cathode) during discharge and reversely when being charged. As an example, a LiPo cell can include a polyethylene (PE), a polypropylene (PP), a PP/PE, or other material as a separator material. Some LiPo cells may include a polymer gel containing an electrolyte solution, which may be, for example, coated onto an electrode surface (e.g., as a separator material layer). As an example, a continuous layer of material may be provided that carries various materials where the continuous material may be folded to form a stack of materials. As an example, the continuous layer of material may be a separator material in that portions of it are disposed between layers of electrode materials (e.g., to separator anode electrode material from cathode electrode material).

Lithium-based batteries can generate substantial heat during rapid charging. Depending on form factor, environment, etc., generated heat energy may not be able to dissipate quickly enough to prevent a rapid temperature increase within a battery. Overheating from rapid charging can result in damage to a battery where such damage can degrade battery performance. As an example, a method can include controlling charging based at least in part on environmental temperature. In such an example, the method may account for one or more other factors such as, for example, thickness, materials, thermal properties, etc. Such a method may utilize one or more charging parameters such as, for example, charging rate (e.g., charging current) and charging time. Such a method can help to maintain performance and longevity of a battery while also providing for more optimal charging.

As an example, a method can provide optimum, dynamic charging control based at least in part on temperature. Such a method may provide for thermal management of a battery or batteries and a device or devices that can be powered by one or more batteries. Such a method may also consider battery capabilities, which may be according to manufacturer specifications and/or actual measurements (e.g., during use, non-use, charging, discharging, etc.).

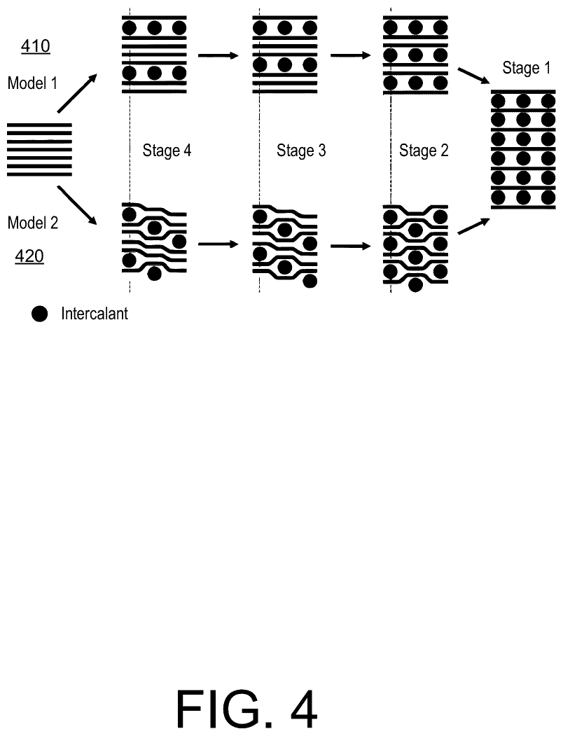

FIG. 4 shows examples of processes 410 and 420 with respect to a first model (Model 1) and a second model (Model 2) where the processes 410 and 420 can affect how heat energy is generated in a battery. For example, consider the Rüdorff model as being Model 1 of the process 410 and the Daumus-Hérold model as being Model 2 of the process 420. In FIG. 4, the processes 410 and 420 are intercalation processes where graphene layers in graphitic carbon can become increasingly spaced and/or distorted due to lithium intercalation. In the process 410, there is a sequential filling up of alternating graphene interlayer spaces with no structural distortions induced within the individual graphene sheets; whereas, in the process 420, the graphene layers are flexible and deform around the intercalating lithium ions. In the processes 410 and 420, distances may be determined. For example, in the process 410, distances between graphene layers can change from being small (e.g., of the order of 3 Å) to being large to fit the intercalant. Ultimately, the processes 410 and 420 can occur in stages (e.g., Stage 4 to Stage 1) where a final intercalation stage (Stage 1) may be the same for both of the processes 410 and 420.

For lithium-ion batteries, during fast charging, lithium ions intercalate into the anode and de-intercalate from the cathode rapidly, leading to a steep lithium concentration gradient that increases resistance. The increase in resistance can, in turn, causes a battery (e.g., one or more cells) to generate heat energy. If the heat energy cannot be sufficiently dissipated on a time scale of the heat generation, then the battery can increase in temperature in a manner that can lead to battery cycle life reduction (e.g., due to electrode breakdown).

Charging and rapidity of charging can depend on various factors. For example, consider lithium-ion access capability of an anode, polarization at a higher current density, lithium-ion plating at an anode surface, etc. Multiple cycles of rapid charging can degrade battery performance, structure, and cycle life. At times, lithium-ion batteries can overheat during a rapid charge and quickly degrade without apparent advance notice. As to the extent of a temperature rise, consider a change during rapid charging of 30 deg C or more. In instances where heat energy cannot be sufficiently dissipated between cycles, a cumulative effect can occur whereby each subsequent cycle may elevate battery temperature even more.

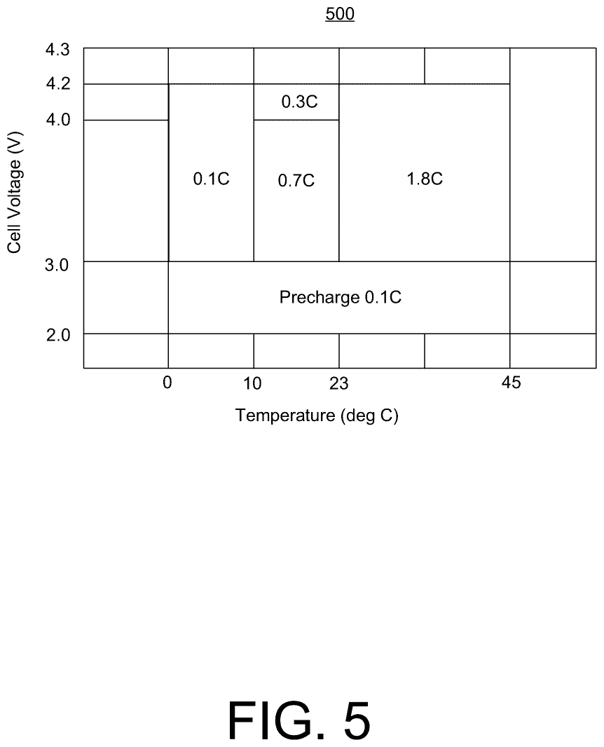

FIG. 5 shows an example of a control scheme 500 as a plot of cell voltage in volts, ranging from less than 2 V to 4.3 V, versus temperature in deg C, ranging from less than 0 deg C to more than 45 deg C. For example, consider charging a battery that is at 2 V and a temperature of 5 deg C. In such an example, a precharge rate of 0.1C is implemented until the battery reaches 3 V. Once the battery reaches 3 V, the charging rate remains the same. However, if the battery is at a temperature of 15 deg C, then, at 3 V, the charging rate is increased from 0.1C to 0.7C, until the battery reaches 4 V, at which time, the charging rate is decreased from 0.7C to 0.3C. As shown in the control scheme 500, if the battery is above 23 deg C (e.g., room temperature), then at 3 V, the charging rate is increased from 0.1C to 1.8C, which remains constant until the battery is fully charged, as represented by the voltage of 4.2 V. In such an approach, the charge rates are controlled by a predetermined temperature range that limits the battery's capability. Such an approach has been implemented to provide a laptop computer with, under particular conditions, a battery charging capability of 80 percent charge in approximately 30 minutes, which can provide for a suitable user experience.

In the example of FIG. 5, the scheme 500 is not dynamic and does not account for heat generation during charging. In particular, the scheme 500 does not promote heat generation during charging at low temperatures (e.g., less than room temperature). In other words, if a battery is at 5 deg C, the scheme 500 will maintain the charging rate 0.1 C until the battery is full charged to 4.2 V. Such an approach may not provide a suitable user experience as going from 2 V to 4.2 V at a charging rate of 0.1 C can take a considerable amount of time.

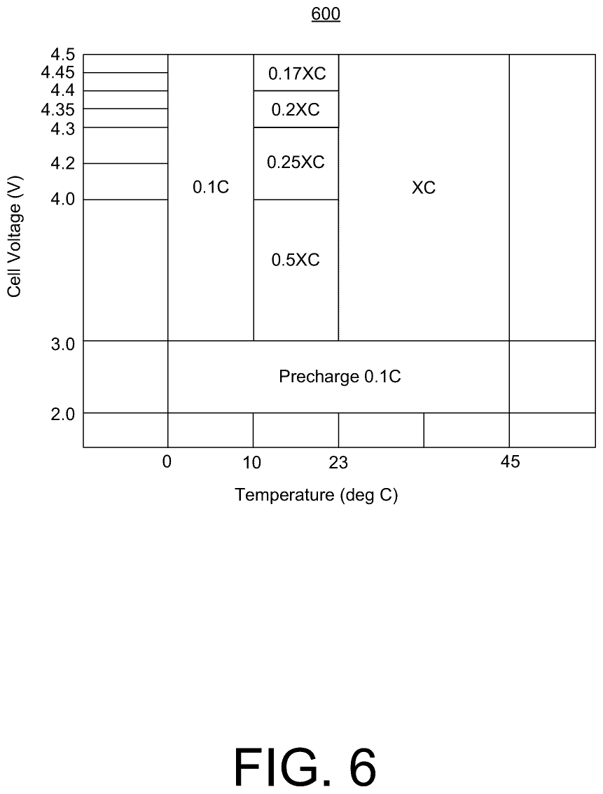

FIG. 6 shows an example of a control scheme 600 that includes an increased number of charging rates in a temperature that is greater than approximately 10 deg C and less than approximately 23 deg C. As shown, the increased number of charging rates include rates for up to 4.5 V where, upon reaching 4 V, the charging rates can be progressively decreased at suitable increments (e.g., 0.1 V, etc.).

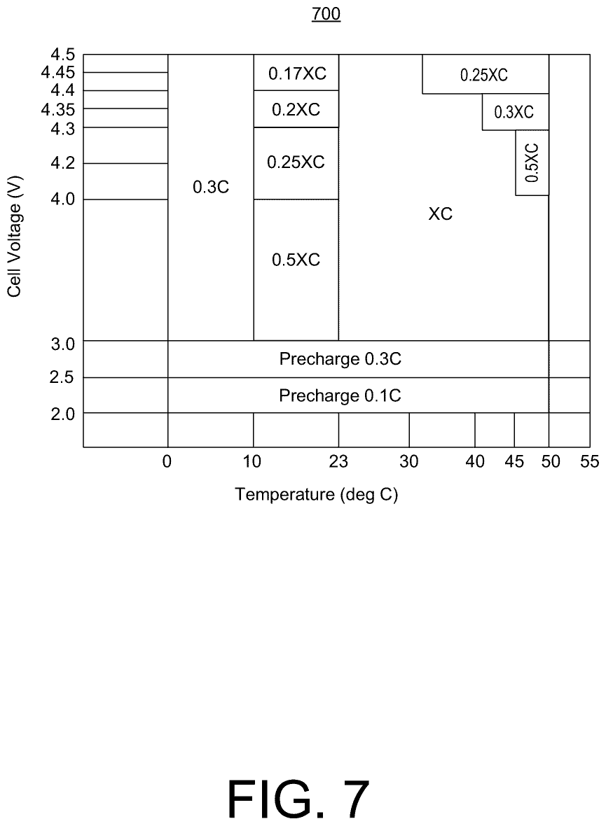

FIG. 7 shows an example of a control scheme 700 that includes an increased number of precharge charging rates and temperature dependent charging rates for temperatures of 30 deg C to 50 deg C, with respect to voltage.

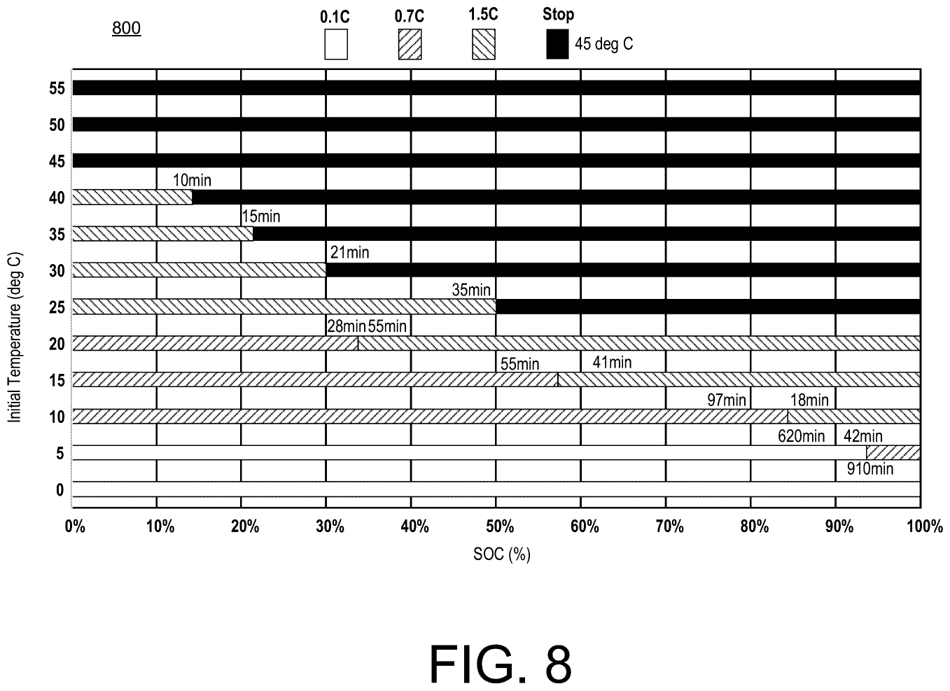

FIG. 8 shows an example plot 800 of initial temperature in deg C versus SOC in percent for various charging rates (e.g., 0.1 C, 0.7 C and 1.5 C) where a cutoff temperature is employed to stop charging (e.g., a temperature of approximately 45 deg C). In the plot 800, various times are indicated that correspond to time at which charging is stopped or at which SOC reaches 100 percent. For example, for an initial temperature of 40 deg C, charging at 1.5 C will stop after 10 minutes because the temperature has reached the cutoff temperature of 45 deg C. However, when stopped, the SOC has progressed from 0 percent to only 14 percent. Hence, user experience would be suboptimal. Similarly, for an initial temperature of 5 deg C, a charging rate of 0.1 C is implemented, which can persist for 620 minutes to reach a SOC of approximately 93 percent. At that time, the charging rate can be increased to 0.7 C for 42 minutes such that the SOC reaches 100 percent. Again, such a lengthy charging time is suboptimal and likely to result in an unacceptable user experience.

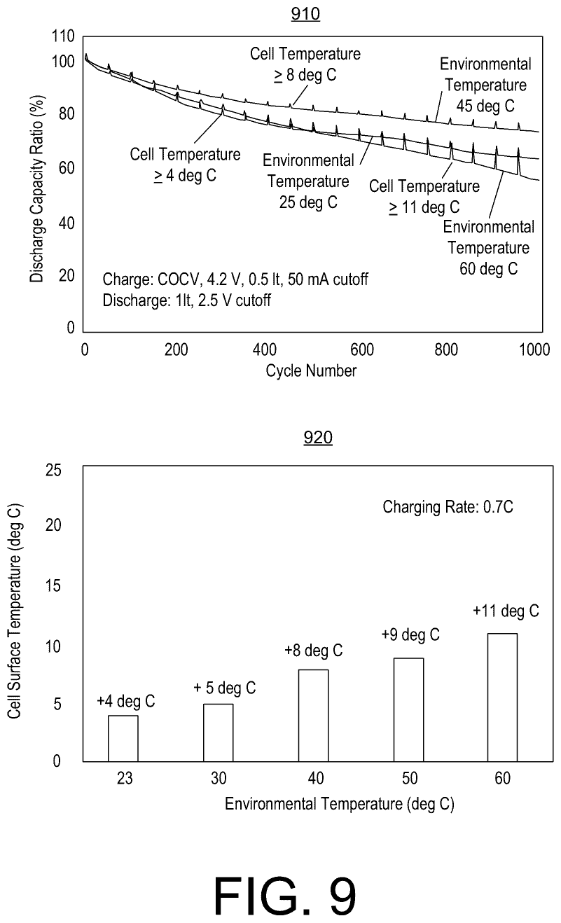

FIG. 9 shows example plots 910 and 920 where the plot 910 is for discharge capacity ratio in percent ranging from 0 percent to 110 percent versus cycle number ranging from 0 to 1000 where data correspond to environmental temperatures of 25 deg C, 45 deg C and 60 deg C and where the plot 920 is for cell surface temperature in deg C ranging from 0 deg C to 25 deg C versus environmental temperature in deg C for temperatures of 23, 30, 40, 50 and 60 deg C, for a charging rate of 0.7C. As shown, the cell surface temperature increases upon charging at 0.7C in a manner that depends on environmental temperature. For example, at 23 deg C, a rise in temperature is 4 deg C; whereas, at 60 deg C, a rise in temperature is 11 deg C.

The plots 910 and 920 provide some insight into internal temperature of a battery. In various scenarios, a battery can tolerate an elevated internal temperature with a high environmental temperature during cycling. For example, in the plot 910, the data for an environmental temperature of 60 deg C at approximately 600 cycles and the data for an environmental temperature of 25 deg C at approximately 600 cycles both correspond to a discharge capacity ratio of approximately 75 percent. Hence, a 35 deg C differential environmental temperature (between 25 and 60 deg C) during cycling does not substantially decrease discharge capacity ratio. However, an environmental temperature of 45 deg C does appear to provide for a higher discharge capacity ratio at 600 cycles. The data in the plot 910 demonstrate that there may be a more optimal environmental temperature, however, maintaining a battery in a 45 deg C environment can be impractical, noting that 25 deg C is closer to room temperature. However, again, the data indicate that a high environmental temperature of 60 deg C does not cause a substantial decrease in performance when compared to the data for 25 deg C. As indicated in the plot 920, at 60 deg C, battery (cell) surface temperature can increase, which can be reasonable equated to an elevated battery (cell) internal temperature while the plot 910 confirms that a battery (cell) can withstand an elevated internal temperature during cycling.

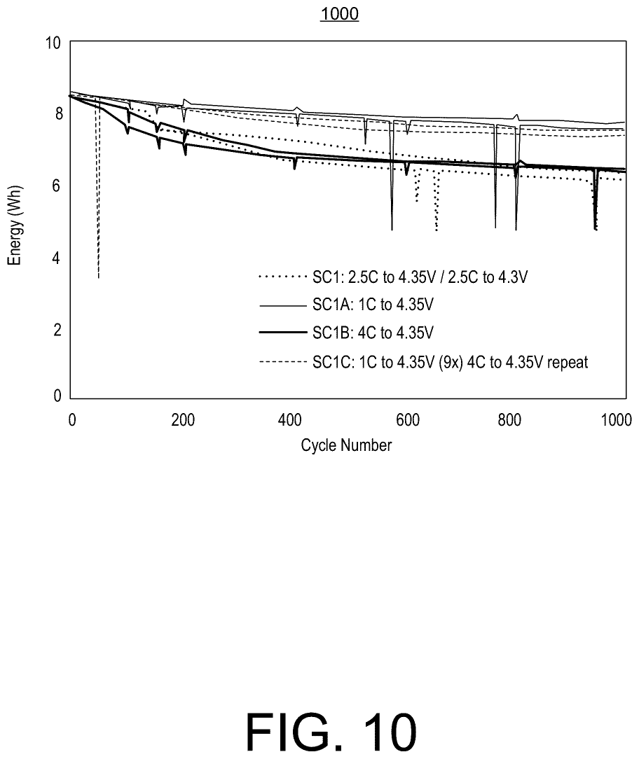

FIG. 10 shows an example plot 1000 of energy in watt-hour (Wh) ranging from 0 Wh to 10 Wh versus cycle number ranging from 0 to 1000 cycles for different charging schemes. The data in the plot 1000 demonstrate that a battery is not detrimentally impacted by increasing the charge rate beyond a specified charging rate (e.g., a manufacturer specified charging rate). Specifically, the plot 1000 shows data for charging schemes with charging rates of 1 C, 2.5 C and 4 C.

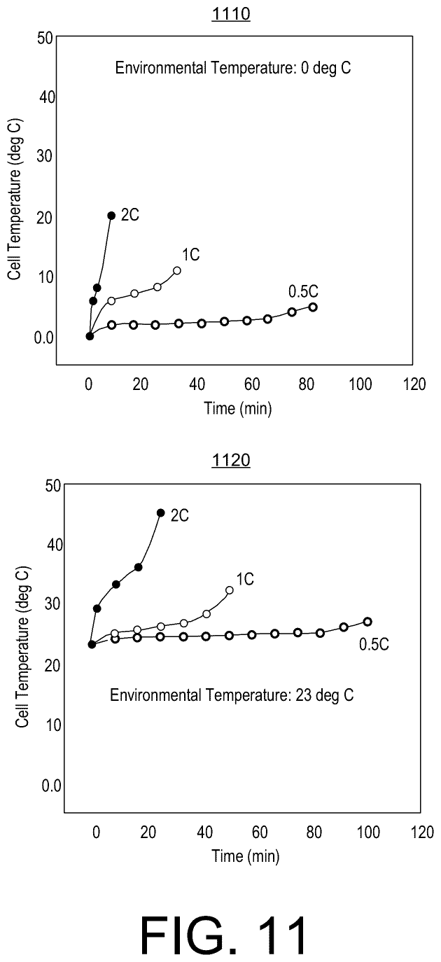

FIG. 11 shows example plots 1110 and 1120 of cell temperature in deg C ranging from 0 deg C to 50 deg C versus time in minutes ranging from 0 to 120 minutes. As shown, the plot 1110 corresponds to an environmental temperature of 0 deg C while the plot 1120 corresponds to an environmental temperature of 23 deg C. In each of the plots 1110 and 1120, data for three different charging rates are shown: 0.50, 1 C and 2 C. As shown, as the charging rate increases, the rise in temperature increases, whether the environmental temperature is at 0 deg C or 23 deg C. In the plot 1110, at 2 C, the temperature is increased from 0 deg C to approximately 20 deg C in less than approximately 10 minutes. As to charging at 1 C, the plot 1110 shows that a rise from 0 deg C to approximately 10 deg C can be achieved in approximately 35 minutes. The data in the plot 1110 demonstrate that a charging rate can be selected to effectuate an increase in cell temperature (battery temperature) in a relatively short period of time (see, e.g., the time in the plot 800 of FIG. 8). Again, as shown in FIG. 11, at 2 C, an increase in temperature of approximately 20 deg C can be achieved in approximately 5 minutes for an environmental temperature of 0 deg C and in approximately 25 minutes for an environmental temperature of 23 deg C.

As explained, a battery may have an optimal temperature range for charging. As an example, a method can include controlling charging rate to increase temperature such that temperature of a “cold” battery may be relatively quickly brought to a temperature near or within its optimal temperature range. Such an approach can differ, for example, from the approach shown in the control scheme 700 of FIG. 7 where, between temperatures of 0 deg C and 10 deg C, a constant charging rate of 0.1 C is implemented. As shown in the plot 1110, the charging rate 0.5 C has a much lesser impact on temperature than higher charging rates. Hence, a charging rate of 0.1 C can be expected to cause even less of a temperature rise than the charging rate of 0.5 C.

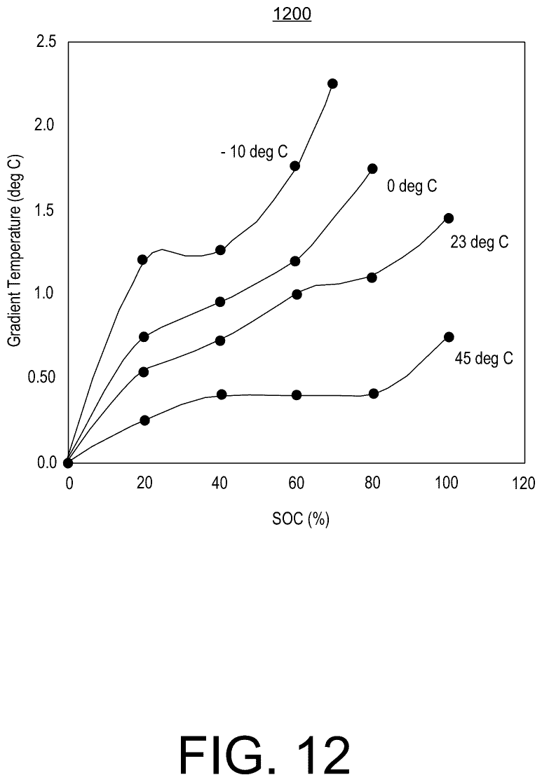

FIG. 12 shows an example plot 1200 of gradient temperature in deg C ranging from 0 deg C to 2.5 deg C versus SOC in percent ranging from 0 to 120. As shown, the gradient temperature depends on environmental temperature where data are presented in the plot 1200 for −10 deg C, 0 deg C, 23 deg C and 45 deg C. In the plot 1200, the gradient temperature is defined as a difference between an internal temperature (e.g., internal center temperature) and surface temperature of a battery. As shown, the lower the environmental temperature, the higher the gradient temperature.

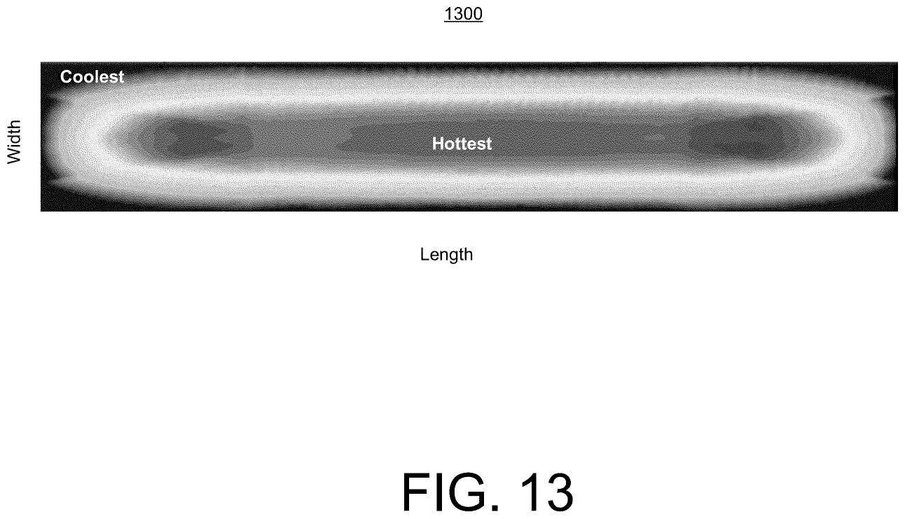

FIG. 13 shows a graphic 1300 of temperature distribution with respect to width and length of a battery. As shown, the hottest temperatures are at or near the center of the battery and the lowest temperatures are at or near the surface of the battery.

As explained, the cell center temperature can be higher than a skin (e.g., surface) temperature. As an example, a method can include taking into account multiple temperatures of a battery for purposes of charge control (e.g., charging rate selection, timing, etc.). As explained, an excess charging rate applied for a relatively short period of time does not manifest in damage to battery longevity. As an example, a method can include receiving one or more temperatures and/or estimating one or more temperatures. For example, a room temperature, a baseboard temperature (e.g., device internal temperature) and/or a surface temperature may be measured. Where a battery includes an internal temperature sensor, an internal temperature may be measured. As an example, one or more models, whether empirical, physics-based, machine-learning-based, etc., may be utilized. For example, given a model and a surface temperature, for particular conditions, an internal temperature (e.g., maximum internal temperature) may be determined and utilized for purposes of charge control. As explained, the lower the environmental temperature, the higher the gradient between surface and internal temperatures whereby a rapid cell temperature increase can be achieved using a relatively high charging rate for a battery in a low temperature environment.

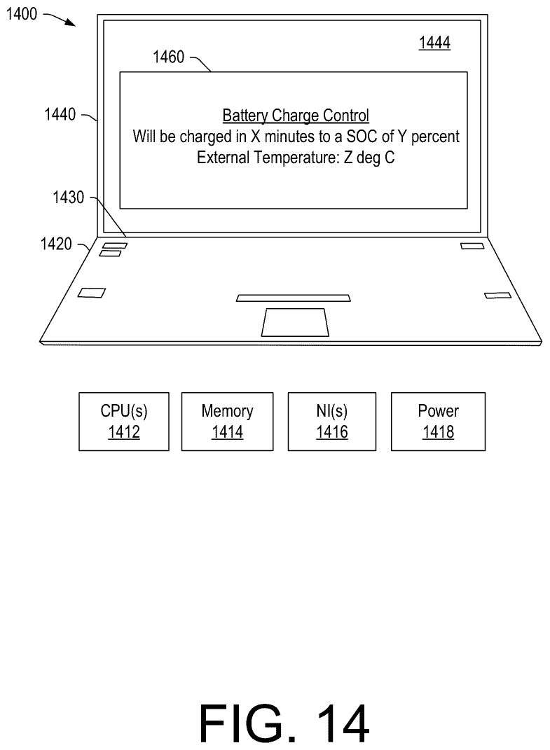

FIG. 14 shows an example of a computing device 1400 that includes a base housing 1420, a hinge assembly 1430 and a display housing 1440 with a display 1444. As an example, the computing device 1400 may include one or more processors 1412, memory 1414 (e.g., one or more memory devices), one or more network interfaces 1416, and one or more power cells 1418. Such components may be, for example, housed within the keyboard housing 1420, the display housing 1440, or the keyboard housing 1420 and the display housing 1440. In the example of FIG. 14, the computing device 1400 can render a graphical user interface (GUI) 1460 to the display 1444. For example, consider the GUI 1460 as being rendered with one or more notifications such as, for example: “Will be charged within X minutes to a SOC of Y percent” and “External Temperature Z deg C”. In such an example, the computing device 1400 can implement a method where charging of a battery (e.g., the one or more power cells 1418) can be controlled.

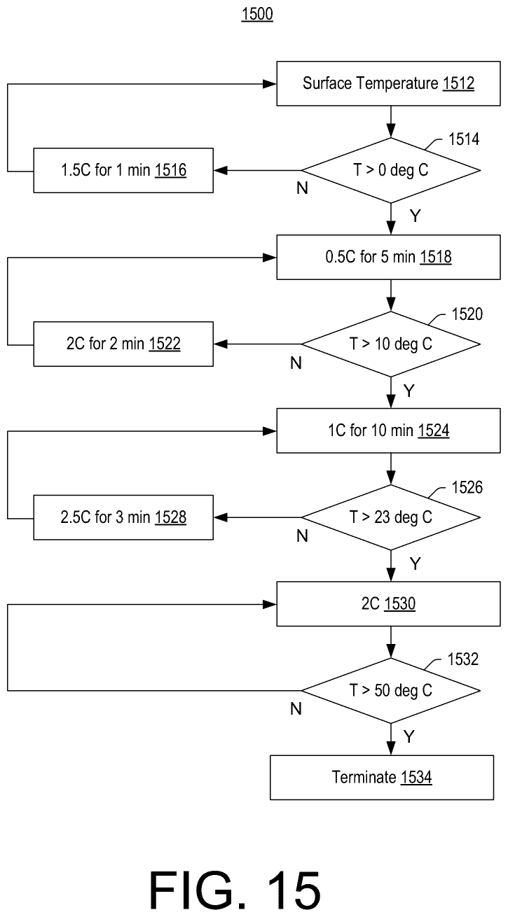

FIG. 15 shows an example of a method 1500 that includes a reception block 1512 for receiving surface temperature, a decision block 1514 for deciding whether the temperature is in excess of 0 deg C, where, if not, the method 1500proceeds to charge block 1516 to charge at a charging rate of 1.5 C for 1 minute; whereas, if the temperature is in excess of 0 deg C, the method 1500 can continue to a charge block 1518 to charge at a charging rate of 0.5 C for 5 minutes, noting that 0.5 C is less than 1.5C. The method 1500 can continue, for example, to a decision block 1520 for deciding whether the temperature is in excess of 10 deg C, where, if not, the method 1500 proceeds to a charge block 1522 to charge at 2 C for 2 minutes; whereas, if the temperature is in excess of 10 deg C, the method 1500 can continue to a charge block 1524 to charge at a charging rate of 1 C for 10 minutes, noting that 1 C is greater than 0.5 C and less than 2 C. As shown, the method 1500 can continue, for example, to a decision block 1526 for deciding whether the temperature is in excess of 23 deg C (e.g., room temperature), where, if not, the method 1500 can continue to a charge block 1528 to charge at a charging rate of 2.5 C for 3 minutes; whereas, if the temperature is in excess of 23 deg C, the method 1500 can continue to a charge block 1530 to charge at a charging rate of 2C. As shown, the method can continue, for example, to a decision block 1532 for deciding whether the temperature is in excess of 50 deg C, where, if not, the method 1500 can continue to the charge block 1530; whereas, if the temperature is in excess of 50 deg C, the method 1500 can proceed to a termination block 1534.

In the example of FIG. 15, the various temperature thresholds, charging rates and charging times are given as examples, noting that more loops or fewer loops may be utilized (e.g., more thresholds or fewer thresholds). The method 1500 can operate to raise the temperature of a “cold” battery to a more optimal temperature for purposes of charging. As shown, a relatively high charging rate may be implemented to cause a battery to generate heat energy that causes the temperature of the battery to rise to a more optimal temperature for purposes of charging. In the example method 1500, a maximum temperature may be specified as a threshold where that threshold can be utilized to call for termination of charging.

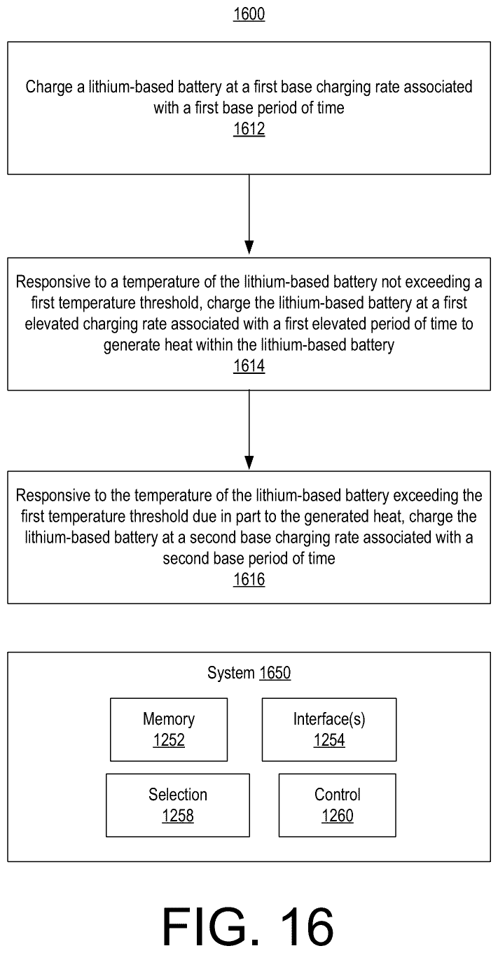

FIG. 16 shows an example of a method 1600 that includes a charge block 1612 for charging a lithium-based battery at a first base charging rate associated with a first base period of time; a charge block 1614 for, responsive to a temperature of the lithium-based battery not exceeding a first temperature threshold, charging the lithium-based battery at a first elevated charging rate associated with a first elevated period of time to generate heat within the lithium-based battery; and a charge block 1616 for, responsive to the temperature of the lithium-based battery exceeding the first temperature threshold due in part to the generated heat, charging the lithium-based battery at a second base charging rate associated with a second base period of time.

FIG. 16 also shows an example of a battery system 1650 that can include memory 1652 that stores information for a battery; an interface 1654 that receives real-time information for the battery; selection circuitry 1658 that, based on the battery abnormality, selects a charging scheme for charging the battery; and control circuitry 1660 that calls for charging the battery using the selected charging scheme. As an example, the battery system 1650 may be operatively coupled to one or more batteries. As an example, the battery system 1650 can include one or more batteries.

As an example, the memory 1652 of the battery system 1650 can provide for storage of instructions where circuitry can include a processor (e.g., controller) that can execute such instructions. In such an example, the instructions may provide for performing one or more actions of the method 1600. For example, one or more of the blocks of the method 1600 can be in the form of instructions stored in a computer-readable medium or computer-readable media executable by a processor to cause a system to perform one or more actions.

As an example, the system 1650 can be a lithium-based battery charging system that includes a temperature sensor interface that receives temperature values indicative of a lithium-based battery temperature; and a controller that controls a battery charging rate and an associated battery charging duration for a lithium-based battery based at least in part on the temperature values to expedite a transition of the lithium-based battery to an optimal temperature charging zone.

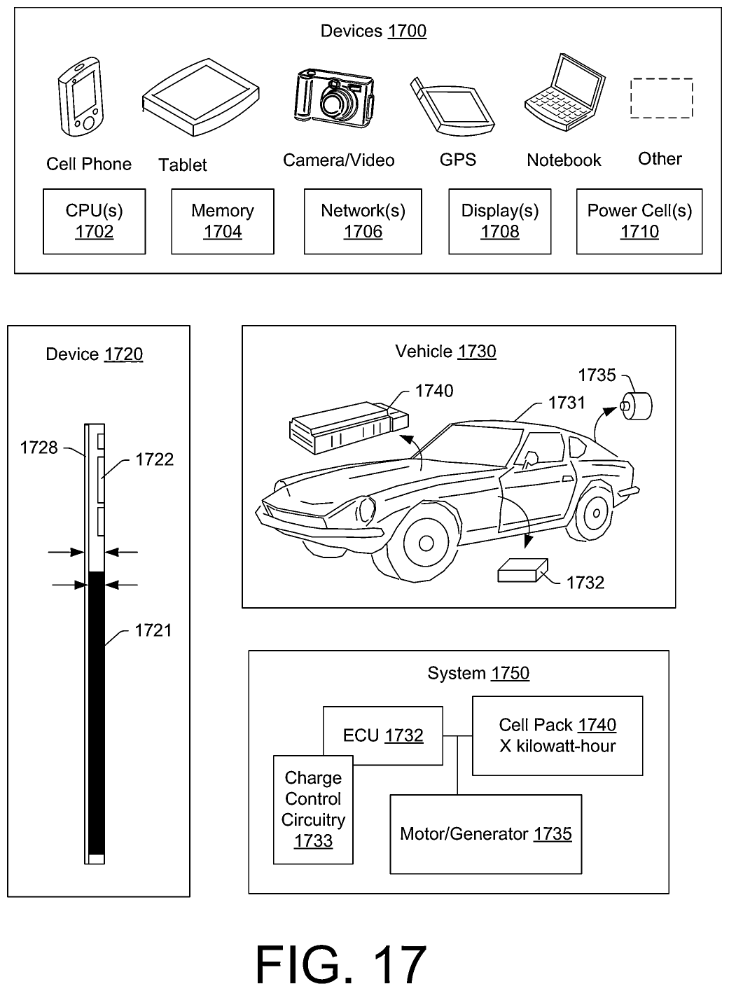

FIG. 17 shows some examples of devices 1700 that may be powered by a battery or batteries (e.g., consider lithium cell or cells (e.g., in the form of a lithium battery or batteries). For example, a cell phone, a tablet, a camera, a GPS device, a notebook computer, or other device may be powered by a lithium cell or cells. As to other devices, a device may be an electric motor of an electric vehicle or a hybrid vehicle. A device may be an automobile, a toy, a remote control device (e.g., a bomb sniffers, drones, etc.), etc. A device may include one or more processors 1702, memory 1704, one or more network interfaces 1706, one or more displays 1708 and, as a power source, one or more power cells 1710 (e.g., lithium-based, etc.).

As an example, a device 1720 may include a power cell(s) 1721, circuitry 1722 and, for example, a display 1728. In such an example, the thickness of the device 1720 may be determined largely by a thickness of the power cell(s) 1721. For example, about 80 percent of the overall thickness of the device 1720 may be determined by a thickness of the power cell(s) 1721.

FIG. 17 also shows an example of a vehicle 1730 that includes an engine control unit (ECU) 1732, a cell pack 1740 and an electric motor and generator 1735 and an example of a system 1750 for the vehicle 1730 that includes the ECU 1732, the cell pack 1740, the electric motor and generator 1735 and charge control circuitry 1733 (e.g., which may be part of the ECU 1732). The vehicle 1730 may include, for example, one or more processors, memory, etc.

As an example, the vehicle 1730 may be a hybrid electric vehicle (HEV) where the cell pack 1740 may, for example, be used to absorb braking energy for immediate re-use in an acceleration cycle (e.g., using the electric motor and generator 1735 as a generator in a regenerative braking scheme). As an example, the vehicle 1730 may be a plug-in hybrid electric vehicle (PHEV) where the cell pack 1740 is rated at about 5.2 kWh to 16 kWh or more, for example, to offer both hybrid and electric drive functions. As an example, the vehicle 1730 may be a battery electric vehicle (BEV) where the cell pack 1740 is rated at about 24 kWh to 200 kWh or more to propel the vehicle 1730.

As an example, a method can include charging a lithium-based battery at a first base charging rate associated with a first base period of time; responsive to a temperature of the lithium-based battery not exceeding a first temperature threshold, charging the lithium-based battery at a first elevated charging rate associated with a first elevated period of time to generate heat within the lithium-based battery; and responsive to the temperature of the lithium-based battery exceeding the first temperature threshold due in part to the generated heat, charging the lithium-based battery at a second base charging rate associated with a second base period of time. In such an example, the generated heat within the lithium-based battery can expedite a transition of the lithium-based battery to an optimal temperature charging zone. As an example, a first temperature threshold can correspond to a temperature that is less than an average temperature of an optimal temperature charging zone.

As an example, a method can include, responsive to temperature of a lithium-based battery exceeding a maximum temperature threshold, terminating charging of the lithium-based battery.

As an example, a first base period of time can be less than a second base period of time. As an example, a first base charging rate can be less than a second base charging rate where, for example, the first base period of time is less than the second base period of time.

As an example, a first elevated period of time can be less than a first base period of time where the first base period of time can be less than a second base period of time.

As an example, a first elevated period of time can be greater than one minute and less than 5 minutes. As an example, a first temperature threshold can be less than 23 degrees C. As an example, a first temperature threshold can be less than 15 degrees C. As an example, a first temperature threshold can be between 18degrees C. and 28 degrees C.

As an example, a method can include, responsive to temperature of a lithium-based battery not exceeding a second temperature threshold, charging the lithium-based battery at a second elevated charging rate associated with a second elevated period of time to generate heat within the lithium-based battery, where a first temperature threshold is less than the second temperature threshold. In such an example, a first elevated period of time can be less than the second elevated period of time. As an example, the first temperature threshold can be less than the second temperature threshold by at least 4 degrees C. As an example, a second temperature threshold can be between 18 degrees C. and 28 degrees C.

As an example, a method can include monitoring a state of charge (SOC) of a lithium-based battery during charging of the lithium-based battery.

As an example, a lithium-based battery charging system can include a temperature sensor interface that receives temperature values indicative of a lithium-based battery temperature; and a controller that controls a battery charging rate and an associated battery charging duration for a lithium-based battery based at least in part on the temperature values to expedite a transition of the lithium-based battery to an optimal temperature charging zone. In such an example, the lithium-based battery charging system can further include at least one temperature sensor that generates the temperature values.

As an example, one or more non-transitory computer-readable media can include processor-executable instructions to instruct a processor-based controller to: charge a lithium-based battery at a first base charging rate associated with a first base period of time; responsive to a temperature of the battery not exceeding a first temperature threshold, charge the lithium-based battery at a first elevated charging rate associated with a first elevated period of time to generate heat within the lithium-based battery; and responsive to the temperature of the lithium-based battery exceeding the first temperature threshold due in part to the generated heat, charge the lithium-based battery at a second base charging rate associated with a second base period of time.

As an example, a computer program product that can include computer-executable instructions to instruct a computing system to perform one or more methods such as one or more of the methods described herein (e.g., in part, in whole and/or in various combinations).

The term “circuit” or “circuitry” is used in the summary, description, and/or claims. As is well known in the art, the term “circuitry” includes all levels of available integration (e.g., from discrete logic circuits to the highest level of circuit integration such as VLSI, and includes programmable logic components programmed to perform the functions of an embodiment as well as general-purpose or special-purpose processors programmed with instructions to perform those functions) that includes at least one physical component such as at least one piece of hardware. A processor can be circuitry. Memory can be circuitry. Circuitry may be processor-based, processor accessible, operatively coupled to a processor, etc. Circuitry may optionally rely on one or more computer-readable media that includes computer-executable instructions. As described herein, a computer-readable medium may be a storage device (e.g., a memory chip, a memory card, a storage disk, etc.) and referred to as a computer-readable storage medium, which is non-transitory and not a signal or a carrier wave.

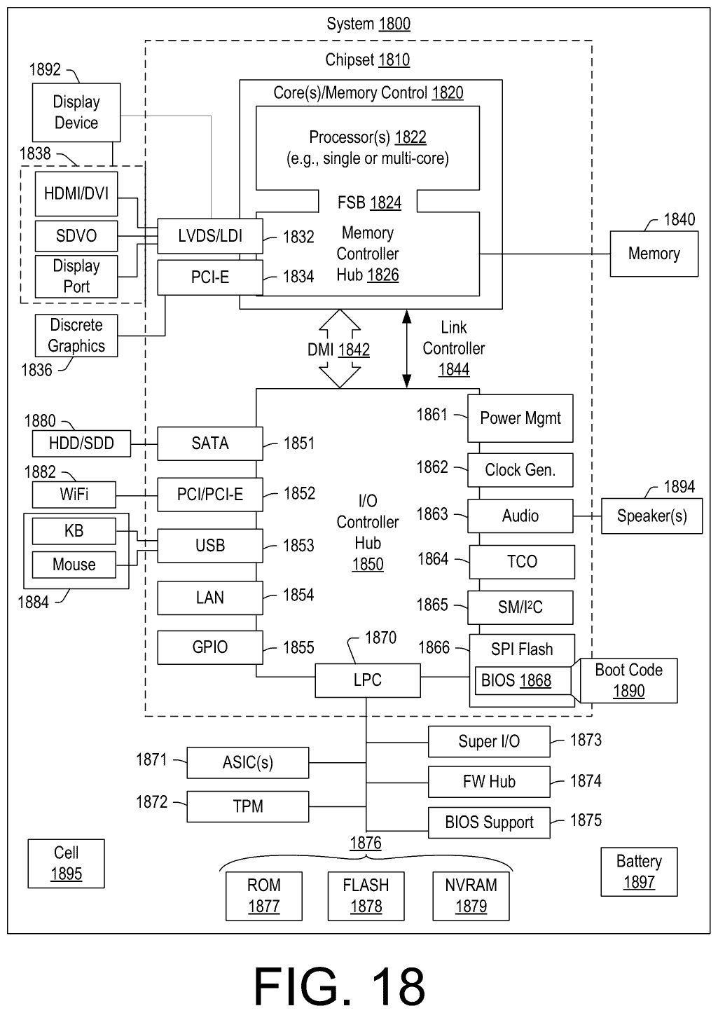

While various examples of circuits or circuitry have been discussed, FIG. 18 depicts a block diagram of an illustrative computer system 1800. The system 1800 may be a computer system, such as one of the ThinkCentre® or ThinkPad® series of personal computers sold by Lenovo (US) Inc. of Morrisville, NC, or a workstation computer system, such as the ThinkStation®, which are sold by Lenovo (US) Inc. of Morrisville, NC; however, as apparent from the description herein, a system or other machine may include other features or only some of the features of the system 1800.

As shown in FIG. 18, the system 1800 includes a so-called chipset 1810. A chipset refers to a group of integrated circuits, or chips, that are designed (e.g., configured) to work together. Chipsets are usually marketed as a single product (e.g., consider chipsets marketed under the brands INTEL®, AMD®, etc.).

In the example of FIG. 18, the chipset 1810 has a particular architecture, which may vary to some extent depending on brand or manufacturer. The architecture of the chipset 1810 includes a core and memory control group 1820 and an I/O controller hub 1850 that exchange information (e.g., data, signals, commands, etc.) via, for example, a direct management interface or direct media interface (DMI) 1842 or a link controller 1844. In the example of FIG. 18, the DMI 1842 is a chip-to-chip interface (sometimes referred to as being a link between a “northbridge” and a “southbridge”).

The core and memory control group 1820 include one or more processors 1822 (e.g., single core or multi-core) and a memory controller hub 1826 that exchange information via a front side bus (FSB) 1824. As described herein, various components of the core and memory control group 1820 may be integrated onto a single processor die, for example, to make a chip that supplants the conventional “northbridge” style architecture.

The memory controller hub 1826 interfaces with memory 1840. For example, the memory controller hub 1826 may provide support for DDR SDRAM memory (e.g., DDR, DDR2, DDR3, etc.). In general, the memory 1840 is a type of random-access memory (RAM). It is often referred to as “system memory”.

The memory controller hub 1826 further includes a low-voltage differential signaling interface (LVDS) 1832. The LVDS 1832 may be a so-called LVDS Display Interface (LDI) for support of a display device 1892 (e.g., a CRT, a flat panel, a projector, etc.). A block 1838 includes some examples of technologies that may be supported via the LVDS interface 1832 (e.g., serial digital video, HDMI/DVI, display port). The memory controller hub 1826 also includes one or more PCI-express interfaces (PCI-E) 1834, for example, for support of discrete graphics 1836. Discrete graphics using a PCI-E interface has become an alternative approach to an accelerated graphics port (AGP). For example, the memory controller hub 1826 may include a 16-lane (x16) PCI-E port for an external PCI-E-based graphics card. A system may include AGP or PCI-E for support of graphics. As described herein, a display may be a sensor display (e.g., configured for receipt of input using a stylus, a finger, etc.). As described herein, a sensor display may rely on resistive sensing, optical sensing, or other type of sensing.

The I/O hub controller 1850 includes a variety of interfaces. The example of FIG. 18 includes a SATA interface 1851, one or more PCI-E interfaces 1852 (optionally one or more legacy PCI interfaces), one or more USB interfaces 1853, a LAN interface 1854 (more generally a network interface), a general purpose I/O interface (GPIO) 1855, a low-pin count (LPC) interface 1870, a power management interface 1861, a clock generator interface 1862, an audio interface 1863 (e.g., for speakers 1894), a total cost of operation (TCO) interface 1864, a system management bus interface (e.g., a multi-master serial computer bus interface) 1865, and a serial peripheral flash memory/controller interface (SPI Flash) 1866, which, in the example of FIG. 18, includes BIOS 1868 and boot code 1890. With respect to network connections, the I/O hub controller 1850 may include integrated gigabit Ethernet controller lines multiplexed with a PCI-E interface port. Other network features may operate independent of a PCI-E interface.

The interfaces of the I/O hub controller 1850 provide for communication with various devices, networks, etc. For example, the SATA interface 1851 provides for reading, writing or reading and writing information on one or more drives 1880 such as HDDs, SDDs or a combination thereof. The I/O hub controller 1850 may also include an advanced host controller interface (AHCI) to support one or more drives 1880. The PCI-E interface 1852 allows for wireless connections 1882 to devices, networks, etc. The USB interface 1853 provides for input devices 1884 such as keyboards (KB), one or more optical sensors, mice and various other devices (e.g., microphones, cameras, phones, storage, media players, etc.). On or more other types of sensors may optionally rely on the USB interface 1853 or another interface (e.g., I2C, etc.). As to microphones, the system 1800 of FIG. 18 may include hardware (e.g., audio card) appropriately configured for receipt of sound (e.g., user voice, ambient sound, etc.).

In the example of FIG. 18, the LPC interface 1870 provides for use of one or more ASICs 1871, a trusted platform module (TPM) 1872, a super I/O 1873, a firmware hub 1874, BIOS support 1875 as well as various types of memory 1876 such as ROM 1877, Flash 1878, and non-volatile RAM (NVRAM) 1879. With respect to the TPM 1872, this module may be in the form of a chip that can be used to authenticate software and hardware devices. For example, a TPM may be capable of performing platform authentication and may be used to verify that a system seeking access is the expected system.

The system 1800, upon power on, may be configured to execute boot code 1890 for the BIOS 1868, as stored within the SPI Flash 1866, and thereafter processes data under the control of one or more operating systems and application software (e.g., stored in system memory 1840). An operating system may be stored in any of a variety of locations and accessed, for example, according to instructions of the BIOS 1868. Again, as described herein, a satellite, a base, a server or other machine may include fewer or more features than shown in the system 1800 of FIG. 18. Further, the system 1800 of FIG. 18 is shown as optionally include cell phone circuitry 1895, which may include GSM, CDMA, etc., types of circuitry configured for coordinated operation with one or more of the other features of the system 1800. Also shown in FIG. 18 is battery circuitry 1897, which may provide one or more battery, power, etc., associated features (e.g., optionally to instruct one or more other components of the system 1800). As an example, a SMBus may be operable via a LPC (see, e.g., the LPC interface 1870), via an I²C interface (see, e.g., the SM/I²C interface 1865), etc.

Although examples of methods, devices, systems, etc., have been described in language specific to structural features and/or methodological acts, it is to be understood that the subject matter defined in the appended claims is not necessarily limited to the specific features or acts described. Rather, the specific features and acts are disclosed as examples of forms of implementing the claimed methods, devices, systems, etc.

What is claimed is:

1. A method comprising:
charging a lithium-based battery at a first base charging rate associated with a first base period of time;
responsive to a temperature of the lithium-based battery not exceeding a first temperature threshold, charging the lithium-based battery at a first elevated charging rate associated with a first elevated period of time to generate heat within the lithium-based battery; and
responsive to the temperature of the lithium-based battery exceeding the first temperature threshold due in part to the generated heat, charging the lithium-based battery at a second base charging rate associated with a second base period of time.

2. The method of claim 1, wherein the generated heat within the lithium-based battery expedites a transition of the lithium-based battery to an optimal temperature charging zone.

3. The method of claim 1, wherein the first temperature threshold corresponds to a temperature that is less than an average temperature of the optimal temperature charging zone.

4. The method of claim 1, comprising responsive to the temperature of the lithium-based battery exceeding a maximum temperature threshold, terminating the charging.

5. The method of claim 1, wherein the first base period of time is less than the second base period of time.

6. The method of claim 1, wherein the first base charging rate is less than the second base charging rate.

7. The method of claim 6, wherein the first base period of time is less than the second base period of time.

8. The method of claim 1, wherein the first elevated period of time is less than the first base period of time and wherein the first base period of time is less than the second base period of time.

9. The method of claim 1, wherein the first elevated period of time is greater than one minute and less than 5 minutes.

10. The method of claim 1, wherein the first temperature threshold is less than 23degrees C.

11. The method of claim 1, wherein the first temperature threshold is less than 15degrees C.

12. The method of claim 1, wherein the first temperature threshold is between 18degrees C. and 28 degrees C.

13. The method of claim 1, comprising responsive to the temperature of the lithium-based battery not exceeding a second temperature threshold, charging the lithium-based battery at a second elevated charging rate associated with a second elevated period of time to generate heat within the lithium-based battery, wherein the first temperature threshold is less than the second temperature threshold.

14. The method of claim 13, wherein the first elevated period of time is less than the second elevated period of time.

15. The method of claim 13, wherein the first temperature threshold is less than the second temperature threshold by at least 4 degrees C.

16. The method of claim 13, wherein the second temperature threshold is between 18degrees C. and 28 degrees C.

17. The method of claim 1, comprising monitoring a state of charge (SOC) of the lithium-based battery during the charging of the lithium-based battery.

18. A lithium-based battery charging system comprising:
a temperature sensor interface that receives temperature values indicative of a lithium-based battery temperature; and
a controller that controls a battery charging rate and an associated battery charging duration for a lithium-based battery based at least in part on the temperature values to expedite a transition of the lithium-based battery to an optimal temperature charging zone.

19. The lithium-based battery charging system of claim 18, further comprising at least one temperature sensor that generates the temperature values.

20. One or more non-transitory computer-readable media comprising processor-executable instructions to instruct a processor-based controller to:
charge a lithium-based battery at a first base charging rate associated with a first base period of time;
responsive to a temperature of the battery not exceeding a first temperature threshold, charge the lithium-based battery at a first elevated charging rate associated with a first elevated period of time to generate heat within the lithium-based battery; and
responsive to the temperature of the lithium-based battery exceeding the first temperature threshold due in part to the generated heat, charge the lithium-based battery at a second base charging rate associated with a second base period of time.
